(19) United States
(12) Patent Application Publication
(10) Pub. No.: US 2022/0263457 A1
(43) Pub. Date: Aug. 18, 2022

(54) Modular, Photovoltaic Utility Pole System

(71) Applicant: THE REGENTS OF THE UNIVERSITY OF MICHIGAN, Ann Arbor, MI (US)

(72) Inventor: Mojtaba AKHAVAN-TAFTI, Ann Arbor, MI (US)

(21) Appl. No.: 17/672,813

(22) Filed: Feb. 16, 2022

Related U.S. Application Data
(60) Provisional application No. 63/150,362, filed on Feb. 17, 2021.

(51) Int. Cl. H02S 20/32; H02S 40/20; H02S 40/40; H02S 40/38; E04H 12/22

(52) U.S. Cl. CPC H02S 20/32; H02S 40/20; E04H 12/2253; H02S 40/38; H02S 40/40

(57) ABSTRACT

A modular, photovoltaic utility pole system comprises an optoelectronic module having a photovoltaic module arranged within a pole having a transparent window. The photovoltaic module having with an optical cross section. The photovoltaic module is configured to convert light to electric current. The modular, photovoltaic utility pole system further comprises an electric management module configured to manage flow of the electric current from the photovoltaic module to an electric device, and a support module configured to affix at least the optoelectronic module to a base.

### CROSS-REFERENCE TO RELATED APPLICATIONS

This application claims the benefit of U.S. Provisional Application No. 63/150,362, filed on Feb. 17, 2021. The entire disclosure of the above application is incorporated herein by reference.

### FIELD

The present disclosure relates to a modular, photovoltaic utility pole system.

### BACKGROUND AND SUMMARY

This section provides background information related to the present disclosure which is not necessarily prior art. This section provides a general summary of the disclosure, and is not a comprehensive disclosure of its full scope or all of its features.

Distributed solar generators are an essential building block of smart microgrids. Microgrids are localized grids that can disconnect from the traditional grid to operate autonomously. Because they are able to operate while the main grid is down, microgrids can strengthen grid resilience and help mitigate grid disturbances as well as function as a grid resource for faster system response and recovery. Microgrids support a flexible and efficient electric grid by enabling the integration of growing deployments of distributed solar installations. In addition, the use of local sources of energy to serve local loads helps reduce energy losses in transmission and distribution, further increasing efficiency of the electric delivery system.

Distributed solar installations can be deployed horizontally as ‘solar farms’ or vertically as ‘solar forests,’ as envisioned by Akhavan-Tafti (U.S. Provisional Patent Ser. No. 63/069,261). The latter is particularly desirable for installations where horizontal solar harvest is not appropriate due to: 1) lack of readily-available real estate, 2) inapt environmental conditions, such as sun-angle, partial shading, wind, snow, and dust, or 3) high cost of operations.

Solar-enabled outdoor lighting and Internet-of-Things (IoT) infrastructure eliminate the cost of running expensive electrical conduits, often as high as $2,000 per foot. Solar-powered platforms also provide electricity savings, reliability (extended operations after a full day of charging), and mobility (can be installed anywhere independent of a power grid). Existing solar-powered platforms often involve mounting a solar panel and batteries on top of a utility pole.

Yoshida and Fujii (U.S. Pat. No. 6,060,658) introduced a solar platform architecture incorporating photovoltaic cells arranged approximately vertically on at least one portion of peripheral wall of the main body of a utility pole that also housed an on-board electric energy storage unit. The arrangement of photovoltaic cells was envisioned to generate and store on-board the electric energy to be consumed by an attached electric device for one day, utilizing solar radiation afforded by sunlight. This transformative architecture allowed solar modules to be wrapped around poles to avoid an increase in wind load associated with mounting bulky solar panels and batteries on a utility pole. The architecture reduced the manufacturing and installation costs of solar-powered utility poles. However, the architecture suffered from drawbacks, including inhomogeneous illumination and rapid degradation (thermal and physical) of the photovoltaic cells and electronics.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 illustrates a schematic of a modular, photovoltaic utility pole system, comprising an optoelectronic module comprising a photovoltaic module with an optical cross section, wherein the photovoltaic module is configured to convert light to electric current and arranged within a pole with a transparent window. The pole is configured to provide at least partial insulation to the photovoltaic module and to enlarge the optical cross section of the photovoltaic module; an electric management module, configured to manage flow of the electric current from the photovoltaic module to an electric device; and a support module to affix at least the optoelectronic module to and extending upward from a base.

FIG. 2 illustrates a cross-sectional schematic of a modular, photovoltaic utility pole system, comprising an optoelectronic module comprising a photovoltaic module with an optical cross section. The pole is configured to provide at least partial insulation to the photovoltaic module and to enlarge the optical cross section of the photovoltaic module.

FIG. 3 illustrates a schematic of a modular, photovoltaic utility pole system, comprising an optoelectronic module comprising a photovoltaic module consisting of one solar panel encased in a transparent pole.

FIG. 4 illustrates a schematic of a modular, photovoltaic utility pole system, comprising an electric management module, configured to receive, store in an on-board electricity storage unit, and distribute the electric current from the photovoltaic module to an electric device. The electric device is a closed-circuit television (CCTV) surveillance camera transmitting information. The support module is directly buried within a permanent concrete form.

FIG. 5 illustrates a schematic of a first and a second modular, photovoltaic utility pole system. The first modular, photovoltaic utility pole system comprising an electric management module. The electric current generated on the second modular, photovoltaic utility pole system is stored in a battery housed within the first modular, photovoltaic utility pole system. The two systems are linked via a grid, a cable. The first modular, photovoltaic utility pole system manages the grid operations and is in communication with a server. The second modular, photovoltaic utility pole system comprises a plurality of optoelectronic modules.

FIG. 6 illustrates a schematic of a modular, photovoltaic utility pole system, comprising an optoelectronic module with a rotational degree of freedom and two auxiliary electricity generators, a wind turbine and a solar panel.

FIG. 7 illustrates a schematic of a modular, photovoltaic utility pole system, comprising an optoelectronic module mounted on an electric utility pole. The support module affixes the transparent pole to the utility pole, supporting overhead power lines and various other public utilities, such as electrical cable and fiber optic cable. The electric management module comprises an inverter to convert the generated electrical current to alternative current (AC) and deposit to the grid.

FIG. 8 illustrates a schematic of a modular, photovoltaic utility pole system, comprising an electric management module, configured to receive, store in an on-board electricity storage unit, and distribute the electric current from the photovoltaic module to an electric device. The electric device is a light-emitting diode (LED) stripe extending along the transparent pole's cavity.

FIG. 9 illustrates a schematic of a modular, photovoltaic utility pole system, comprising an electric management module that is housed with the transparent pole with a 360-degree light collection optical cross section. Installation instructions are provided by a device, in this case, a compass to ensure that the module faces a per-determined direction.

FIG. 10 illustrates a schematic of a serviceable modular, photovoltaic utility pole system, comprising an optoelectronic module an attainable photovoltaic module having a locking mechanism, configured to affix the photovoltaic module and a set of attainable terminals. The transparent window is attached to the pole with hinges. The transparent window can be replaced for improved optical characteristics. The inner surface of the pole is coated with reflective material, such as a mirror.

FIG. 11 illustrates a schematic of an optoelectronic module. The photovoltaic cells are sealed within a transparent enclosure, such as encased in polymeric resin or enclosed in an air-sealed tube.

FIG. 12 illustrates a schematic of a modular, photovoltaic utility pole system equipped with convective heat transfer. Convective heat transfer is managed by a venting system.

FIG. 13 illustrates a schematic of a modular, photovoltaic utility pole system equipped with a thermal management system. The pole temperature is regulated with a latent phase change material (PCM) such as wax.

FIG. 14 illustrates a schematic of a modular, photovoltaic utility pole system comprising an optoelectronic module. The photovoltaic module comprising a plurality of photovoltaic cells with at least translational or rotational degrees of freedom. The degrees of freedom configured to improve power output based on solar inputs.

FIG. 15 illustrates a schematic of a solar forest. A solar forest comprising of a plurality of modular, photovoltaic utility pole system. The modular, photovoltaic utility pole system comprising of a support module with at least translational or rotational degrees of freedom. The degrees of freedom are configured to improve power output by optimizing light collection. The degrees of freedom also configured to prevent cross-shading.

FIG. 16 illustrates a cross-sectional schematic of a modular, photovoltaic utility pole system, comprising an optoelectronic module comprising a photovoltaic module. The photovoltaic module at least partially covered by a reflective surface, a mirror, arranged over the outer surface of the pole. The mirror is equipped with at least one rotational degree of freedom. The mirror is configured to improve power output by enhancing light collection.

FIG. 17 illustrates a cross-sectional schematic of a modular, photovoltaic utility pole system, comprising an optoelectronic module comprising a photovoltaic module. The photovoltaic module at least partially covered by a reflective surface, a mirror, arranged within the pole cavity. The mirror is equipped with at least one rotational degree of freedom. The mirror is configured to improve power output by enhancing light collection.

FIG. 18 illustrates a schematic of a modular, photovoltaic utility pole system configured to wrap around an existing (retrofitting) light pole as an auxiliary electricity source.

FIG. 19 illustrates a schematic of a modular, photovoltaic utility pole system configured to be installed on top of an existing (retrofitting) electric utility pole. The system configured to provide electricity during power oscillations to help with load balance.

FIG. 20 illustrates a schematic of a modular, photovoltaic utility pole system configured to be installed on a wall. The system configured to provide electricity to an electric device, such as an outdoor lighting fixture or a surveillance camera.

FIG. 21 illustrates a schematic of a modular, photovoltaic utility pole system configured to be installed on a wall. The system configured to provide electricity to an electric device, such as a light emitting diode. The system comprises a motion sensor coupled with a central processing unit.

FIG. 22 illustrates a schematic of a modular, photovoltaic utility pole system configured to wrap around an existing (retrofitting) traffic signage in the form of a removable ‘sleeve.’ The system can provide improved visibility to an existing traffic signage. Additional system can also be mounted on top of the sign.

FIG. 23 illustrates a schematic of a modular, photovoltaic utility pole system configured to provide electricity for geofencing applications, such as motion-sensitive fence or an electric fence.

FIG. 24 illustrates a schematic of a modular, photovoltaic utility pole system configured to provide electricity for charging platforms, such as an electric scooter charging platform.

FIG. 25 illustrates a schematic of a modular, photovoltaic utility pole system configured to provide electricity for charging platforms, such as a platform for wireless charging of unmanned aerial vehicles.

FIG. 26 illustrates a schematic of a modular, photovoltaic utility pole system configured to provide natural lighting and electricity for indoor spaces.

FIG. 27 illustrates a schematic of a modular, photovoltaic utility pole system with a support module that is lattice structure.

FIG. 28 illustrates a schematic of a modular, photovoltaic utility pole system with a lattice structure providing support to the photovoltaic module.

FIG. 29 illustrates a schematic of a modular, photovoltaic utility pole system. Modular architecture improves system transportability and installation.

FIG. 30 illustrates a schematic of a modular, photovoltaic utility pole system with at least one electrical component of the electric management module stored within the support module. This can avoid theft. It further can provide temperature regulation.

FIG. 31 illustrates a schematic of a plurality of modular, photovoltaic utility pole systems. The systems linked to create a local microgrid to provide electricity for smart road infrastructure, such as lighting and dynamic electric vehicle charging. The local microgrid can further provide power to local communities during power outages.

Corresponding reference numerals indicate corresponding parts throughout the several views of the drawings.

### DETAILED DESCRIPTION

Example embodiments will now be described more fully with reference to the accompanying drawings.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

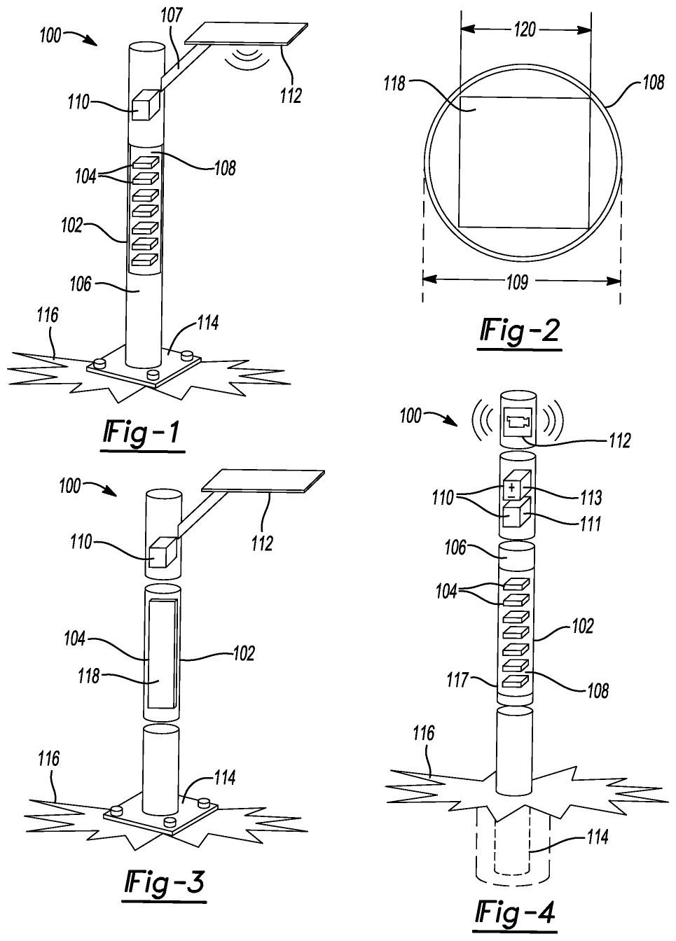

According to the principles of the present teachings, and with reference to FIG. 1, a modular, photovoltaic utility pole system 100 comprises an optoelectronic module 102 comprising a photovoltaic module 104 arranged within a pole 106 having a transparent window 108. The photovoltaic module 104 converts light to electric current. The modular, photovoltaic utility pole system 100 further comprises an electric management module 110 that is configured to manage flow of the electric current from the photovoltaic module 104 to an electric device 112. The modular, photovoltaic utility pole system 100 also comprises a support module 114 to affix at least the optoelectronic module 102 to a base 116. In some embodiments, the support module 114 further affixes an arm 107. In some embodiments, the support module 114 further affixes an item selected from a group consisting of a signage, a traffic signage, a sensor, a mast, a staff, a chain, a cable, a bar, a tag, a barcode, a bird spike, an advertisement, a banner, a display, a decoration, an auxiliary electricity generator, and a charging platform.

In reference to FIG. 2, in some embodiments, the photovoltaic module comprises an optical cross section 120, defined as the light collection area, which is smaller than the cross section of the transparent window 108, referred to as ‘optoelectronic module optical cross section’ 109. In some embodiments, the photovoltaic module optical cross section 120 is smaller than the optoelectronic module optical cross section 109 only at certain sun angles. In some embodiments, the optoelectronic module optical cross section 109 improves the amount of light captured by each photovoltaic cell 118.

The term ‘transparent’ refers to materials whose light transmission ratio is greater than zero. Transparency in this context is defined as the physical property of allowing electromagnetic energy to propagate within a material, at least partially or in entirety of the electromagnetic spectrum, with or without appreciable scattering.

In reference to FIG. 3, in some embodiments, the photovoltaic module 104 is a single photovoltaic cell 118. In some embodiments, the photovoltaic module 104 comprises a plurality of photovoltaic cells 118 arranged in a planar structure, such as a solar panel. In some embodiments, the photovoltaic module 104 comprises a plurality of photovoltaic cells 118 arranged in a non-planar format, such as a curved surface using flexible solar panels. In some embodiments, a plurality of photovoltaic cells 118 are arranged in a three-dimensional format, as described in commonly assigned U.S. patent application Ser. No. 17/408,925, which is hereby incorporated by reference, wherein a plurality of non-coplanar photovoltaic cells 118 are vertically stacked on top of one another at a distance interval, as shown in FIG. 1.

In some embodiments, the photovoltaic module 104 comprises a plurality of photovoltaic cells 118, selected from a group consisting of inorganic materials, organic materials, and a combination thereof. In some embodiments, the photovoltaic module 104 comprises a plurality of bifacial photovoltaic cells 118 configured to convert direct and reflected light. In some embodiments, the photovoltaic module 104 comprises a plurality of reflective layers. In some embodiments, the photovoltaic module 104 comprises a plurality of light diffusive layers. In some embodiments, the photovoltaic module 104 is a printed layer. In some embodiments, photovoltaic cell 118 refers to a layer of photovoltaic material configured to convert light to electric current. In some embodiments, photovoltaic cell 118 refers to a discrete layer of photovoltaic material. In some embodiments, photovoltaic cell 118 refers to a surface within which at least one photovoltaic material is deposited. In some embodiments, the photovoltaic module 104 is an origami photovoltaic layer.

In reference to FIG. 4, in some embodiments, the electric management module 110 comprises an electric component 111. In some embodiments, electric component 111 comprises a converter, such as maximum power point tracking unit or micro-inverter, pulse width modulation system, electric current surge protector, battery management system, a switch, a diode, or combinations thereof. In some embodiments, the electric management module 110 comprises a power storage unit 113, such as an electrochemical cell, electro-thermal cell, electro-mechanical cell, solid-state cell, and supercapacitor.

In some embodiments, the electric management module 110 comprises a configurable controller unit, such as a central processing unit (CPU). In some embodiments, the configurable controller unit comprises analog and/or digital input and output gates. In some embodiments, the electric management module 110 is programmable.

In some embodiments, the electric management module 110 manages flow of current between at least two of the photovoltaic module 104, the power storage unit 113, and electric device 112. In some embodiments, the electric management module 110 changes flow of the electric current to at least one of power storage unit 113 and an electric device 112, based on a characteristic of the electric current of the photovoltaic module.

In some embodiments, the electric management module 110 comprises a configurable micro-controller unit to which one or a plurality of electric components 111 are connected. In some embodiments, the electric management module 110 comprises a sensor, wherein the electric management module 110 comprises an electric component 111, namely a sensor generating a signal, wherein the electric management module 110 changes flow of the electric current to an electric device 112 based on the signal from the sensor. In some embodiments, the sensor is selected from a list of an active sensor, a passive sensor, a contact sensor, and a non-contact sensor. In some embodiments, the sensor is selected from a list of an optical sensor, a mechanical sensor, a chemical sensor, a magnetic sensor, a thermal sensor, an electric sensor, and a physical sensor.

In some embodiments, the electric management module 110 comprises an electric component 111, namely a communication unit. In some embodiments, the communication unit can receive and/or send information. In some embodiments, the information communicated via the communication unit comprises at least one of data, media, text message, signal, and voice message. In some embodiments, the communication unit communicates with a server. In some embodiments, a server coordinates operation(s) of one or a plurality of modular, photovoltaic utility pole systems 100. In some embodiments, an operator in the loop, such as a utility point of contact, coordinates operation(s) of one or a plurality of modular, photovoltaic utility pole systems 100.

In reference to FIGS. 1-4, in some embodiments, a modular, photovoltaic utility pole system 100 comprises an optoelectronic module 102 having a photovoltaic module 104 arranged within a pole 106 having a transparent window 108. In this embodiment, the photovoltaic module 104 comprises a plurality of non-coplanar photovoltaic cells 118 all oriented at an angle 45 degrees to horizon. In this embodiment, the angle was determined based on the average solar radiation at Ann Arbor, Mich. A comprehensive list of appropriate average solar angles for various geographical latitudes and time of year are provided by the National Renewable Energy Laboratory (NREL); accordingly, the photovoltaic module 104 can comprise a plurality of non-coplanar photovoltaic cells 118 all oriented at an angle relative to horizon that is based on the appropriate average solar angles for the particular geographical latitude and time of year (or average thereof) provided by the National Renewable Energy Laboratory (NREL). In some embodiments, the plurality of non-coplanar photovoltaic cells 118 are attached to a support structure having discrete slots. The attachment can be achieved using 3D-printed holders, also defined as a locking mechanism 126. In some embodiments, the distance between adjacent photovoltaic cells 118 can be shorter than the width of the photovoltaic cells 118, allowing to pack more photovoltaic surfaces inside the transparent window 108 than an embodiment in which photovoltaic cells 118 are positioned vertically in a planar configuration.

In some embodiments, the pole 106 is a steel pole. The pole 106 can comprise a transparent pole, herein referred to as a transparent window 108 with a 360-degree view of the surroundings, positioned atop the steel pole. It should be understood that transparent window 108 can comprise alternative configurations or less than 360-degree views, unless otherwise specifically stated. Temperature inside the pole 106 can increase with increasing direct solar radiation. Therefore, the top and bottom of the steel pole can be open for air flow. The top of the transparent pole can be covered by a water-proof cap. The cap can enable air flow for temperature regulation.

In some embodiments, the photovoltaic module 104 converts light to electric current via two groups of five photovoltaic cells 118 configured in series, allowing a desired output voltage. The two groups can be connected in parallel. In some embodiments, an additional photovoltaic cell 118 can be included (but not electrically connected to other photovoltaic cells 118) at the top of the photovoltaic module 104 with the same physical characteristics (orientation and distance) to ensure that all of the photovoltaic cells 118 have identical optoelectronic module optical cross section 109. This can enable uniform light input across all photovoltaic cells 108, hence avoiding mismatched electric current outputs.

In some embodiments, the modular, photovoltaic utility pole system 100 comprises an electric management module 110 that is configured to manage flow of the electric current from the photovoltaic module 104 to a power storage unit 113 and an electric device 112. In some embodiments, the modular, photovoltaic utility pole system 100 comprises a maximum power tracking system having three electric terminals for photovoltaic input, power storage, and load. In some embodiments, the maximum power tracking system can send and receive information via Bluetooth, USB, and WiFi/LAN/Internet, enabling remote operation, monitoring, system configuration, and software updates. The maximum power tracking system can further directly connect, using a cable, to monitor and store system performance.

In some embodiments, the power storage unit 113 is a lithium battery. The battery can be directly connected to the power storage plugs of the maximum power tracking system. In some embodiments, the electric device 112 comprises a light emitting diode strip as well as a ground fault circuit interrupter (GFCI) plug having both direct (USB and USB-C) and alternating current outlets. The electric device 112 can connect to the load plugs of the maximum power tracking system via an inverter to convert direct current (DC) to alternating current (AC). In some embodiments, the electric management module 110, power storage unit 113, and electric device 112 can be disposed within the steel pole, and can be accessible via removable, water-proof windows.

In some embodiments, the modular, photovoltaic utility pole system 100 further comprises a support module 114 to affix at least the optoelectronic module 102 to a base 116. In some embodiments, the support module 114 is a steel plate welded to the steel pole. The modular, photovoltaic utility pole system 100 can be installed on a concrete floor by drilling four 0.5-inch holes matching those of the steel plate and using four bolts to hold the system in place.

In some embodiments, the electric device 112 is an equipment that utilizes electromagnetic force. In some embodiments, electric device 112 is selected from a group consisting of an electromagnetic system, an electroluminescent system, an electrothermal system, an electromechanical system, and an electrochemical system.

In some embodiments, the pole 106 is configured in a vertical arrangement. In some embodiments, the pole 106 is configured in a columnar structure. In some embodiments, the pole 106 is at least partially transparent. In some embodiments, the pole 106 is at least partially reflective. In some embodiments, the pole 106 is at least partially absorptive. In some embodiments, the pole 106 is partitioned into transparent and non-transparent parts. The transparent part, referred to herein as the transparent window 108, has a numerical aperture greater than zero. The photovoltaic module 104 receives light transmitting through the transparent window 108. In some embodiments, the transparent window 108 extends beyond the pole 106 to collect more light. In some embodiments, the transparent window 108 is an optic 117, such as a cylindrical lens, curved polymer slab, or prismatic glass, configured to guide light. In some embodiments, the transparent window 108 is configured to capture reflected light. In some embodiments, the pole 106 is equipped with excess material for improved structural integrity.

The numerical aperture (NA) of an optical system is a dimensionless number that characterizes the range of angles over which the system can accept or emit light. The numerical aperture of an optical system such as a convex lens is defined by NA=n sin(θ), where n is the index of refraction of the medium in which the optical system is working and θ is the maximal half-angle of the cone of light that can enter or exit the lens.

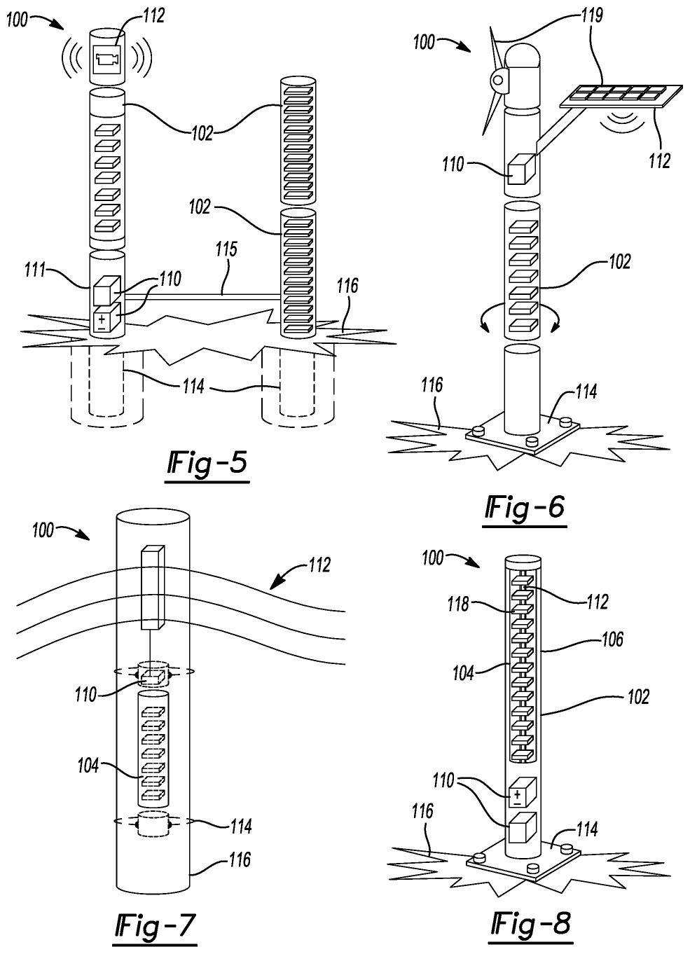

In reference to FIG. 5, in some embodiments, the electric management module 110 comprises an electric component 111 shared between a plurality of optoelectronic modules 102. In some embodiments, the plurality of optoelectronic modules 102 are linked to an electric management module 110 via an electrical conduit 115, such as a cable.

In reference to FIG. 6, in some embodiments, the modular, photovoltaic utility pole system 100 comprises a single or a plurality of auxiliary electricity generators 119. In some embodiments, the auxiliary electricity generators 119 is selected from a group consisting of a wind turbine, a solar panel, a thermophotovoltaic system, a thermoelectric generator, a piezoelectric generator, and a fossil fuel backup generator.

In reference to at least FIGS. 1, 3-10, 12, 13-15, 18, and 31, in some embodiments, the modular, photovoltaic utility pole system 100 comprises a support module 114 to affix the system to an electric utility pole. In some embodiments, the electric current generated by the modular, photovoltaic utility pole system 100 is deposited onto a community-wide electric grid or a microgrid to deliver power to an electric device 112 or a power bank. In some embodiments, the electric management module 110 comprises an inverter to convert direct electric current (DC) from the photovoltaic module 104 into alternating electric current (AC). In some embodiments, the modular, photovoltaic utility pole system 100 is utilized as a node in an electric grid. In some embodiments, the modular, photovoltaic utility pole system 100 is utilized as an electric utility pole with power generation and storage capabilities. The modular, photovoltaic utility pole system 100 serving as an electric utility pole provides power resilience to a localized microgrid, especially during power oscillations, such as power outages during natural disasters. In some embodiments, the modular, photovoltaic utility pole system 100 further comprises a communication module. In some embodiments, a server, such as a utility operator, monitors, configures, and operates the modular, photovoltaic utility pole system 100.

In reference to FIG. 8 some embodiments, the modular, photovoltaic utility pole system 100 comprises an electric device 112 that is embedded within the pole 106. In some embodiments, the electric device 112 is a string of light emitting diodes (LEDs). In some embodiments, embedding the electric device 112 within the pole 106 provides a compact packaging of photovoltaic module 104 and electronics.

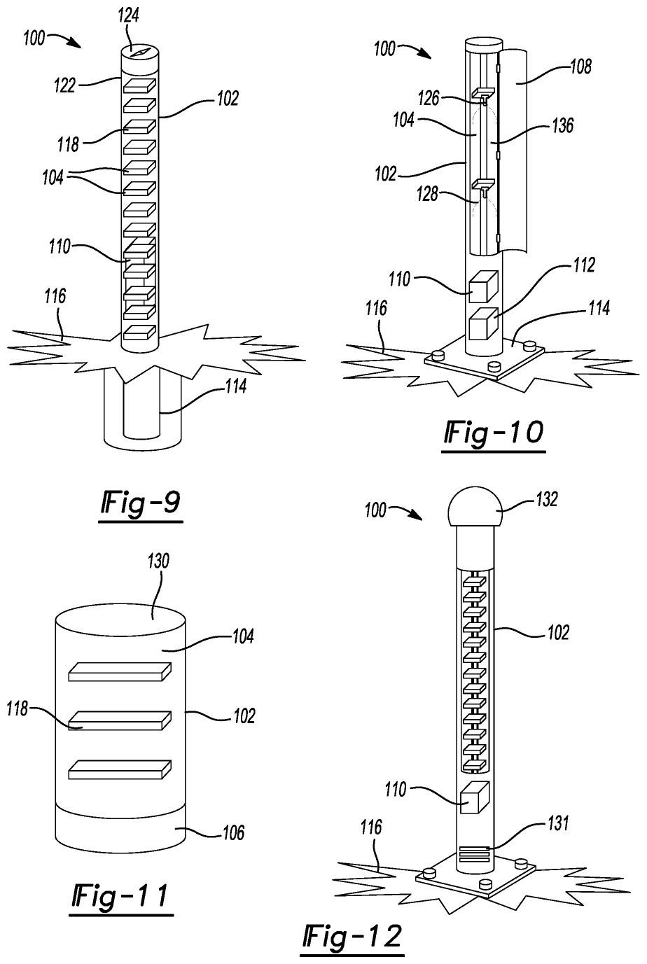

In reference to FIG. 9, in some embodiments, the pole 106 with a transparent window 108 has a numerical aperture NA=1, that is 360-degree optical cross section. A pole 106 with NA=1 is also referred to as a ‘transparent pole’ 122.

In some embodiments, the modular, photovoltaic utility pole system 100 integrates the photovoltaic module 104 within the pole 106 in a way that is cost efficient and reduces maintenance. Specifically, photovoltaic cells 118 of photovoltaic module 104 are deployed within the pole 106 with the transparent window 108 that provides an enclosure for electric devices 112, such as lights and Internet-of-Things (IoT) sub-systems, as well as the packaging for the photovoltaic cells 118. In some embodiments, the modular, photovoltaic utility pole system 100 delivers at least one of several advantages over conventional systems:
a. Cost savings:
   i. Manufacturing: a) the heavy and costly glass, back-sheet, and frame of the solar panel are eliminated, b) our columnar design avoids wind load management costs to support a solar panel and battery attached to a pole, and c) modules can be mass-manufactured and affordably assembled.
   ii. Module performance: a) photovoltaic cell 118 efficiency does not degrade under intense sunlight (at 0.4% per degree Celsius) as convective heat transfer dampens the temperature rise in the columnar structure, b) the transparent pole 122 provides latent solar tracking to improve the daily power output of optoelectronic module 102, and c) photovoltaic cells 118 are homogeneously illuminated resulting in improved power output and enhancing the operational life expectancy of photovoltaic cells 118.
   iii. Maintenance: transparent pole 122 serves as a protective surface that, being vertical, sheds dirt and snow more readily than a solar panel deployed at an angle. Transparent pole 122 further protects the photovoltaic cells 118 and electronics from moisture.
b. Improved reliability: the number of optoelectronic modules 102 can be increased and/or additional modular, photovoltaic utility pole system 100 can be installed and linked to improve total power output and increase power margins, compared to mounting more solar panels on a pole.
c. Improved mobility and versatility: the modular architecture allows for i) easy transportation, and ii) plug and play installations.

In some embodiments, installation instructions are provided for the modular, photovoltaic utility pole system 100. In some embodiments, the instructions are in the form of a compass 124. In some embodiments, the support module 114 affixes the optoelectronic module 102 according to at least one of solar noon, shading from surrounding objects, reflectivity from surrounding objects, aesthetic, traffic, and safety. In some embodiments, the support module 114 faces a pre-determined direction. In some embodiments, the direction is determined based on shading patterns. In some embodiments, the ‘transparent pole’ 122 is coated with materials to prevent dirt or snow buildup and avoid partial shading.

Solar noon is the moment when the Sun passes a location's meridian and reaches its highest position in the sky. In most cases, it does not happen at 12 o'clock. A meridian is an imaginary line connecting the North and South Poles along the Earth's surface. It connects all locations that share the same longitude. The line is also referred to as local meridian.

Solar noon happens at a geographical location when the Earth's rotation brings the location's local meridian to the side of the planet that faces the Sun. At Solar Noon, the Sun reaches its highest position in the sky. Since solar time depends on the longitude, solar noon occurs at exactly the same moment in all locations that share the same local meridian. The exact instant of solar noon, when the Sun reaches its highest point in the sky, varies with the seasons. This variation is called the equation of time; the magnitude of variation is about 30 minutes over the course of a year.

In reference to FIG. 10, in some embodiments the modular, photovoltaic utility pole system 100, wherein the optoelectronic module 102 is serviceable, comprises an attainable photovoltaic module 104 having a locking mechanism 126 configured to affix the photovoltaic module 104 and a set of attainable terminals 128. In some embodiments, the photovoltaic module 104 comprises a racking system to affix individual photovoltaic cells 118. In some embodiments, the locking mechanism 126 comprises a holder, such as a receptacle, capable of sliding along a support railing system, i.e., continuous translation. In some embodiments, the locking mechanism 126 comprises a holder to lock a photovoltaic cell 118 into a pre-determined slot. In some embodiments, the slot locations are determined based on a dimension of the photovoltaic cell 118. In some embodiments, the transparent window 108 is removable. In some embodiments, the optoelectronic module 102 is removable. In some embodiments, the optoelectronic module 102 is at least partially replaceable. In some embodiments, the transparent window 108 is sealed after a service is completed. In some embodiments, the optoelectronic module 102 is depressurized after a service is completed. In some embodiments, the photovoltaic module 104 comprises a reflective rear surface 136 whereon photovoltaic cells 118 are mounted.

In reference to FIG. 11, in some embodiments, the photovoltaic module 104 is encased in a sealed enclosure 130. In some embodiments, the sealed enclosure 130 is a transparent column. In some embodiments, the sealed enclosure 130 is a polymeric slab, such as resin, silicone, or gel. In some embodiments, the photovoltaic cells 118 encased within the sealed enclosure 130 are attainable. In some embodiments, the photovoltaic cells 118 encased within the sealed enclosure 130 can slide in and out of a polymeric mold. In some embodiments, the sealed enclosure 130 has a pre-determined chemical composition, such as pressurized with inert gas. In such embodiments, the sealed enclosure 130 contains materials, such as decanter to remove moisture, to regulate chemical composition. In some embodiments, the photovoltaic cells 118 encased within the sealed enclosure 130 is placed into a pole 106. In some embodiments, the optoelectronic module 102 comprises photovoltaic cells 118 encased within the sealed enclosure 130.

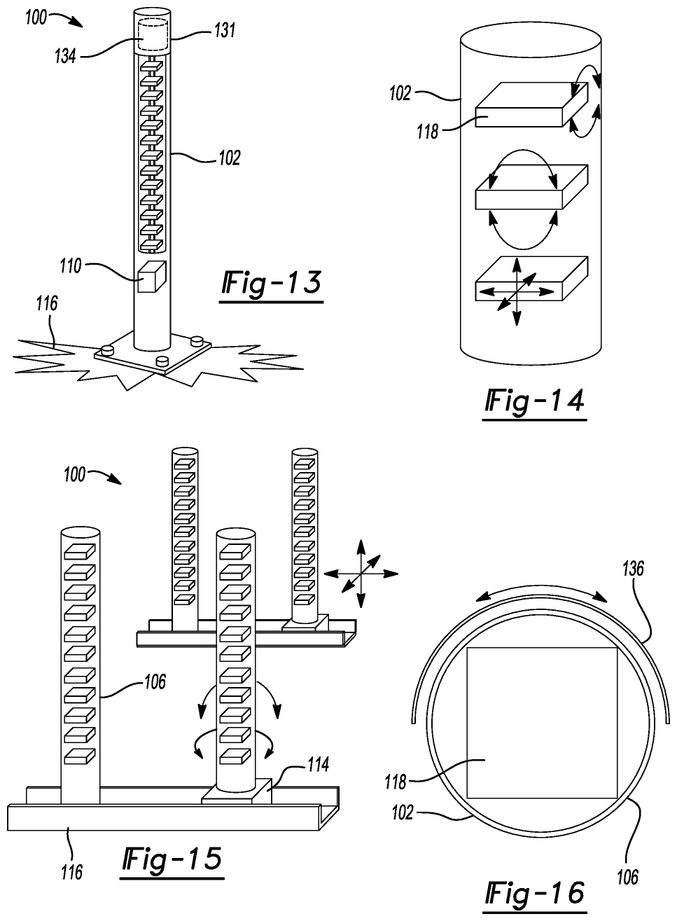

In reference to FIGS. 12 and 13, in some embodiments, the modular, photovoltaic utility pole system 100 is equipped with a temperature regulation mechanism 131. In some embodiments, the temperature regulation mechanism 131 comprises a vent 132. In some embodiments, the temperature regulation mechanism 131 creates heat convection to regulate the temperature inside the optoelectronic module 102. In some embodiments, the temperature regulation mechanism 131 is part of an air circulation mechanism. In some embodiments, the air circulation mechanism 131 comprises a fan. In some embodiments, as illustrated in FIG. 13, the temperature regulation mechanism 131 comprises a phase change material (PCM) 134, such as wax and fat. In some embodiments, the PCM 134 is selected based on a desired temperature. In some embodiments, the temperature regulation mechanism 131 comprises an active temperature regulation system, which, in some embodiments, comprises an electric pump. In some embodiments, the temperature regulation mechanism 131 comprises a coolant circulation mechanism. In some embodiments, the temperature regulation mechanism 131 comprises a material that also serves as a light guide. In some embodiments, the temperature regulation mechanism 131 comprises a thermal capture mechanism, therefore harvesting thermal energy, also referred to as ‘thermo-photovoltaic’ mechanism.

In reference to FIGS. 14 and 15, in some embodiments, the modular, photovoltaic utility pole system 100 is adjustable. In some embodiments, at least one photovoltaic cell 118 of the optoelectronic module 102 is adjustable. In some embodiments, the photovoltaic cell 118 has at least one of translational and rotational degrees of freedom. In some embodiments, the pole 106 of the modular, photovoltaic utility pole system 100 is adjustable. In some embodiments, the pole 106 has at least one of translational and rotational degrees of freedom. In some embodiments, the support module 114 of the modular, photovoltaic utility pole system 100 is adjustable. In some embodiments, the support module 114 has at least one of translational and rotational degrees of freedom.

In some embodiments, at least one of a plurality of modular, photovoltaic utility pole systems 100, a solar forest, move to optimize collective power output. In some embodiments, a plurality of modular, photovoltaic utility pole systems 100 are affixed to a base 116, such as a railing system. In some embodiments, a plurality of modular, photovoltaic utility pole systems 100 are affixed by one support module 114. In some embodiments, the one support module 114 is adjustable. In some embodiments, the one adjustable support module 114 has at least one translation and rotational degrees of freedom. In some embodiments, the one adjustable support module 114 moves to optimize collective power output. In some embodiments, the base 116 is reflective, such as white-painted floor.

In some embodiments, the modular, photovoltaic utility pole system 100 tracks the Sun in the sky. In some embodiments, the solar tracking is manual. In some embodiments, the solar tracking is automatic. In some embodiments, the solar tracking is powered electro-mechanically. In some embodiments, the solar tracking is done using a thermo-mechanical actuator. In some embodiments, a plurality of photovoltaic cells 118 of the optoelectronic module 102 are adjusted as a group. In some embodiments, each of the plurality of photovoltaic cells 118 of the optoelectronic module 102 is adjusted individually.

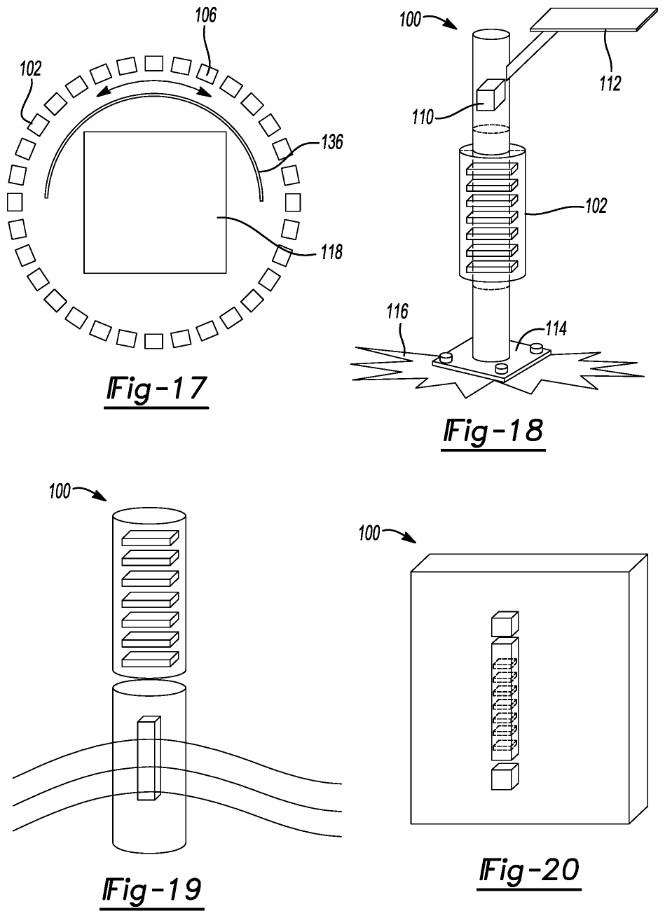

In reference to FIGS. 16 and 17, in some embodiments, a reflective surface 136, such as a mirror, is arranged vertically along the outer surface of the pole 106 of the optoelectronic module 102. In some embodiments, the reflective surface 136 is arranged vertically within the pole 106 of the optoelectronic module 102. In some embodiments, the reflective surface 136 affixes the photovoltaic cells 118. In some embodiments, the reflective surface 136 is adjustable, having at least one of translational and rotational degrees of freedom. In some embodiments, the photovoltaic cells 118 of the optoelectronic module 102 are affixed to the reflective surface 136. In some embodiments, the reflective surface 136 diffuses light. In some embodiments, the reflective surface 136 reflects at least partially. In some embodiments, the reflective surface 136 is configured to converge light. In some embodiments, the reflective surface 136 is configured to diverge light. In some embodiments, only part of the reflective surface 136 is configured to concentrate light. In some embodiments, the reflective surface 136 comprises one or more adjustable discrete reflective surfaces.

In reference to FIGS. 18-22, in some embodiments, the modular, photovoltaic utility pole system 100 is retrofitted to an existing platform as a primary source of electricity. In some embodiments, the modular, photovoltaic utility pole system 100 is retrofitted to an existing platform as an auxiliary source of electricity, often referred to as a ‘hybrid’ platform. In some embodiments, the existing platform is a light pole, utility pole, a wall, or a traffic signage. In some embodiments, the modular, photovoltaic utility pole system 100 wraps around the body of an existing platform, commonly referred to as a ‘sleeve.’

In reference to FIG. 20, in some embodiments, a modular, photovoltaic utility pole system 100 comprises an optoelectronic module 102 comprising a photovoltaic module 104 arranged within a pole 106 having a transparent window 108 was constructed. In some embodiments, the photovoltaic module 104 comprises a plurality of non-coplanar photovoltaic cells 118 all oriented at an angle. In some embodiments, the angle is determined based on the inner diameter of the pole 106. In some embodiments, the support module 114 affixes the optoelectronic module 102 according to at least one of solar noon, shading from surrounding objects, reflectivity from surrounding objects, aesthetic, traffic, and safety.

In some embodiments, the plurality of non-coplanar photovoltaic cells 118 are attached to a 3D-printed support structure having discrete mounting slots. In this embodiment, the distance between adjacent photovoltaic cells 118 was shorter than the width of the photovoltaic cells 118, allowing to pack more photovoltaic surfaces inside the transparent window 108 than an embodiment in which photovoltaic cells 118 are positioned vertically in a planar configuration.

In some embodiments, the pole 106 comprises an aluminum back plate and a transparent window, a transparent window 108 with a 180-degree view of the surroundings, that is NA=0.5. The top and bottom of the pole 106 can be capped. The aluminum back plate can have a semi-circle cross section with fins, serving both as a light reflector, a reflective surface 136, as well as a heat sink.

In some embodiments, the photovoltaic module 104 converting light to electric current is arranged in three groups of three photovoltaic cells 118 configured in series, allowing a desired output voltage. The three groups were then connected in parallel. In this embodiment, an additional photovoltaic cell 118 is included (but not electrically connected to other photovoltaic cells 118) at the top of the photovoltaic module 104 with the same physical characteristics (orientation and distance) to ensure that all of the photovoltaic cells 118 had identical optoelectronic module optical cross section 109. This allows for uniform light input across all photovoltaic cells 108, hence avoiding mismatched electric current outputs.

In some embodiments, the modular, photovoltaic utility pole system 100 further comprises an electric management module 110, comprising a diode, positioned within the bottom cap, that is configured to manage flow of the electric current from the photovoltaic module 104 to a power storage unit 113, a battery pack of eight AA Nickel metal hydride rechargeable batteries. In some embodiments, the electric management module 110 further comprises a configurable and programmable microcontroller. The microcontroller connects the battery pack to an electric device 112, a light emitting diode (LED).

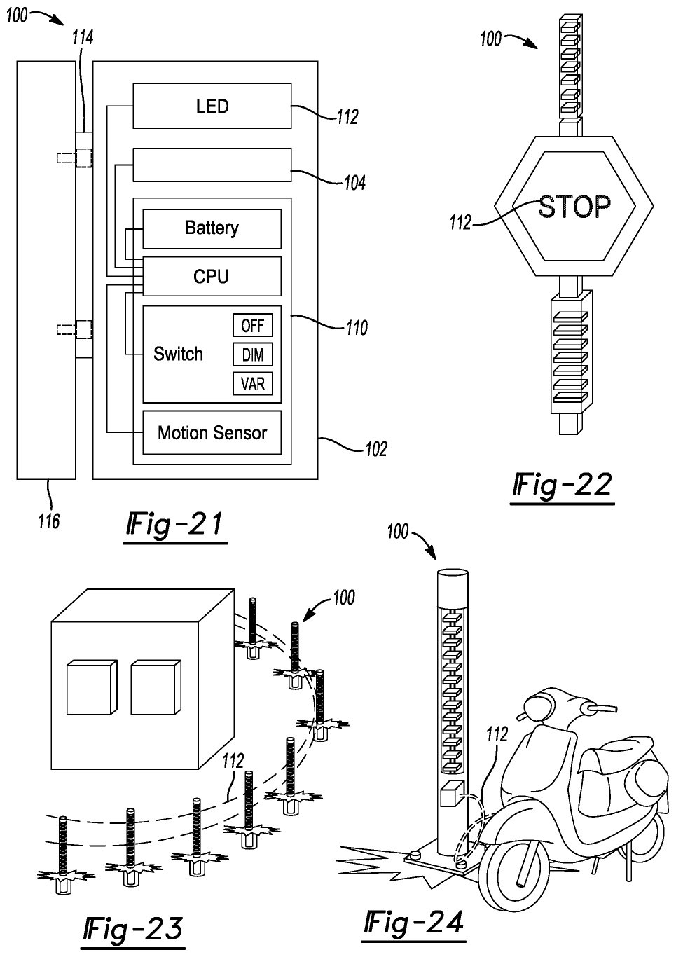

In reference to FIG. 21, in some embodiments, the electric management module 110 further comprises a sensor generating a signal, wherein the electric management module changes flow of the electric current to an electric device based on the signal from the sensor. In some embodiments, the electric management module 110 further comprises a motion detection sensor. The micro-controller can be programmed to provide small average (root-mean squared (RMS)) current to the LED when no motion was detected, hence ‘dim’ illumination. The illumination brightness can be controlled using a pulsed width modulation (PWM) technique. The LED became ‘bright’ for a pre-determined duration as soon as motion was detected. This configuration allows electricity conservation, and therefore, increases reliability.

In some embodiments, the electric management module 110 enables the flow of current to an electric device 112 when solar radiation falls under a threshold brightness, resulting in reduced output voltage of the photovoltaic module 104. In some embodiments, the flow of electric current to an electric device 112 is shut off when solar radiation reaches a threshold brightness, resulting in the output voltage of the photovoltaic module 104 reaching a pre-determined value. In some embodiments, this is referred to as the ‘dusk-to-dawn’ operation.

In some embodiments, the electric management module 110, power storage unit 113, and electric device 112 is stored inside the top and bottom caps, accessible through removable, water-proof windows.

The modular, photovoltaic utility pole system 100 further comprises a support module 114 to affix at least the optoelectronic module 102 to a base 116. In some embodiments, the support module 114 is a mounting pad that is installed on a wall using two screws. The optoelectronic module 102 is then slid over the pad and the height is adjusted for optimal configuration.

In some embodiments, the modular, photovoltaic utility pole system 100 provides electricity to an electro-chemical plant, such as a carbon capture system, a water desalination plant, or a water collection system. In some embodiments, the modular, photovoltaic utility pole system 100 provides electricity for ‘vertical farming’ sub-systems. In some embodiments, the modular, photovoltaic utility pole system 100 further provides housing for ‘vertical farming’ sub-systems.

In reference to FIG. 23, in some embodiments, the modular, photovoltaic utility pole system 100 is configured to provide electricity for electric operations, such as an electric fence, a motion-sensitive fence, a surveillance fence, or a geofence.

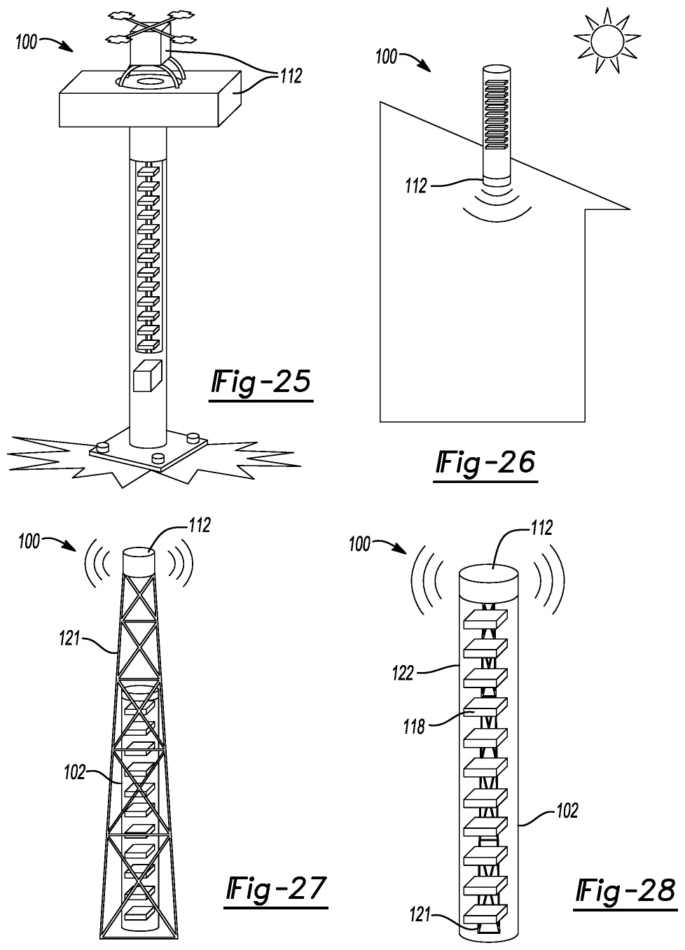

In reference to FIGS. 24-25, in some embodiments, the modular, photovoltaic utility pole system 100 is utilized to provide electricity to a charging platform. In some embodiments, the charging platform delivers electricity with or without a cable (wireless, such as via inductive charging platform). In some embodiments, the modular, photovoltaic utility pole system 100 provides charging to a micro-mobility platform, such as an electric scooter charging platform, smart bike locker platform, unmanned aerial vehicle charging platform, electric device charging platform, smart parking platform. In some embodiments, the modular, photovoltaic utility pole system 100 comprises communications sub-systems, such as a mesh network sub-systems, telecommunication sub-systems, cellular (such as 5G network) communication sub-systems, wireless communication sub-systems, or internet access sub-systems (such as a hotspot).

In reference to FIG. 26, in some embodiments, the modular, photovoltaic utility pole system 100 is configured to also provide natural light to an indoor space during the day. In some embodiments, the modular, photovoltaic utility pole system 100 converts sunlight to electricity for an electric device 112, such as indoor lighting.

In reference to FIGS. 27-28, in some embodiments, the modular, photovoltaic utility pole system 100 the optoelectronic module 102 is positioned inside a lattice structure 121. In some embodiments, a lattice structure 121 is utilized to affix the photovoltaic cells 118. In some embodiments, the pole 106 is a lattice structure 121. In some embodiments, a lattice structure 121 is utilized to provide structural strength to the optoelectronic module 102. In some embodiments, a lattice structure 121 helps to reduce weight, therefore save on construction material costs. In some embodiments, a lattice structure 121 offers flexible configuration with improved transportation and fabrication advantages. In some embodiments, a lattice structure 121 significantly reduces wind load.

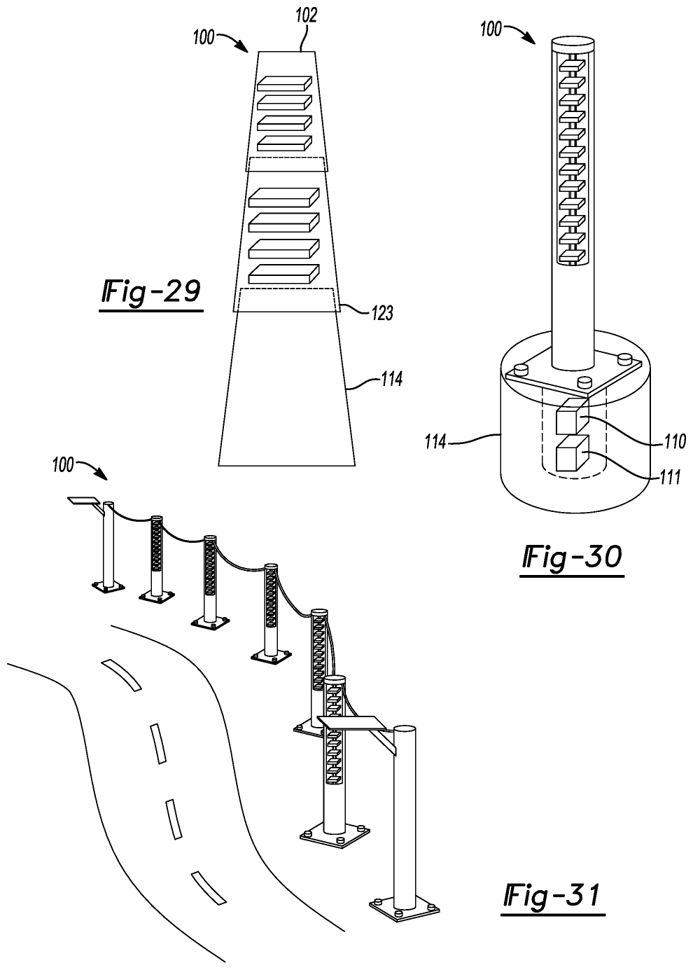

In reference to FIG. 29, in some embodiments, the modular, photovoltaic utility pole system 100 is configured to be assembled on site. In some embodiments, at least one of the support module 114 and optoelectronic module 102 is designed with an interlocking mechanism 123 amongst modules for easy assembly.

In reference to FIG. 30, in some embodiments, at least one electric component 111 of the electric management module 110 is positioned inside the support module 114. In some embodiments, at least one electric component 111 of the electric management module 110 is positioned inside the base 116. In some embodiments, at least one electric component 111 of the electric management module 110 is positioned inside a pole concrete base to avoid theft. In some embodiments, at least one electric component 111 of the electric management module 110 is positioned underground for temperature regulation. In some embodiments, an electric component 111, such as a magnetometer sensor, is placed inside the pole 106 or buried underground within the base 116 to reduce electromagnetic noise.

In some embodiments, support module 114 is selected from a group consisting of a mounting pole, a utility pole, a light pole, a post, a bracket, a concrete foundation, a bollard, an anchor, a frame, a mounting bracket, a clamp, a rail, a magnetic plate, a rope, a chain, a wire, a cable, an arm, a leg, a hook, a hanger, a strut, a mounting fastener, a wall mount, and a belt.

In some embodiments, the base 116 is selected from a group consisting of a floor, a ground, a surface, a wall, a mounting pole, a utility pole, a light pole, a post, a bracket, a bucket, a container, a flowerpot, a structure, a bollard, an anchor, and a frame.

In reference to FIG. 31, in some embodiments, the modular, photovoltaic utility pole system 100 is utilized as a node on a power distribution line. In some embodiments, a plurality of modular, photovoltaic utility pole systems 100 are installed along a road to provide electricity for dynamic electric vehicle charging, lighting, etc. In some embodiments, installing a plurality of modular, photovoltaic utility pole systems 100 along a road helps to avoid land acquisition requirements. In some embodiments, a plurality of modular, photovoltaic utility pole systems 100 are part of a microgrid, configured to provide electricity to electric consumers throughout the day. In some embodiments, a plurality of modular, photovoltaic utility pole systems 100 are utilized as a backup power generator during power outages. In some embodiments, a plurality of modular, photovoltaic utility pole systems 100 are utilized to provide electricity to an off-grid operation, such as an electric vehicle charging station.

The modular, photovoltaic utility pole system 100 does not include embodiments in which one or a plurality of photovoltaic cells 118 are arranged approximately vertically on at least one portion of peripheral wall of the pole 106, as described by Yoshida and Fujii (U.S. Pat. No. 6,060,658). The pole 106 with a transparent window 108 of a modular, photovoltaic utility pole system 100, must: 1) provide at least partial insulation to the photovoltaic module 104, and 2) enlarge the optical cross section of the photovoltaic module 104.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A modular, photovoltaic utility pole system, comprising:
an optoelectronic module having a photovoltaic module arranged within a pole having a transparent window, the photovoltaic module having an optical cross section, the photovoltaic module is configured to convert light to electric current, the pole is configured to provide at least partial insulation to the photovoltaic module and to enlarge the optical cross section of the photovoltaic module;
an electric management module configured to manage flow of the electric current from the photovoltaic module to an electric device; and
a support module configured to affix at least the optoelectronic module to a base.

2. The modular, photovoltaic utility pole system of claim 1, wherein the photovoltaic module comprises at least one photovoltaic cell.

3. The modular, photovoltaic utility pole system of claim 1, wherein the transparent window has a numerical aperture greater than zero.

4. The modular, photovoltaic utility pole system of claim 1, wherein the transparent window is selected from a group consisting of glass and polymer.

5. The modular, photovoltaic utility pole system of claim 1, wherein the transparent window is configured to transmit a selective range of light wavelengths.

6. The modular, photovoltaic utility pole system of claim 1, wherein the photovoltaic module comprises a locking mechanism and a set of attainable terminals.

7. The modular, photovoltaic utility pole system of claim 1, wherein the optoelectronic module comprises a reflective surface.

8. The modular, photovoltaic utility pole system of claim 1, wherein the photovoltaic module is sealed within an enclosure.

9. The modular, photovoltaic utility pole system of claim 1, wherein the electric management module comprises a sensor generating a signal, wherein the electric management module changes flow of the electric current to an electric device based on the signal from the sensor.

10. The modular, photovoltaic utility pole system of claim 1, wherein the optoelectronic module comprises a temperature regulation mechanism.

11. The modular, photovoltaic utility pole system of claim 1, wherein the optoelectronic module comprises a light tracking mechanism.

12. The modular, photovoltaic utility pole system of claim 1, wherein the electric management module comprises an item selected from a group consisting of a battery, a capacitor, a diode, a fuel cell, an auxiliary electricity generator, an inverter, a resistor, an inductor, and a transformer.

13. The modular, photovoltaic utility pole system of claim 1, wherein the electric management module is attached to an electric grid.

14. The modular, photovoltaic utility pole system of claim 1, wherein the electric device is selected from a group consisting of a light source, a sensor, a computer, an electronic system, an Internet-of-Things sub-system, a telecommunication sub-system, an active traffic signage, a traffic warning, a speaker, display, a device charging platform, a vehicle charging platform, a surveillance sub-system, a cathodic protection sub-system, an agriculture monitoring sub-system, an interactive platform sub-system, a heater, an electro-mechanical system, an electro-thermal system, an electro-chemical system, a renewable power generation sub-system, a renewable material production sub-system, a power-over-ethernet system, a public safety sub-system, and a personal asset safety sub-system.

15. The modular, photovoltaic utility pole system of claim 1, wherein the electric device is on an electric grid.

16. The modular, photovoltaic utility pole system of claim 1, wherein the support module is selected from a group consisting of a mounting pole, a utility pole, a light pole, a post, a bracket, a concrete foundation, a bollard, an anchor, a frame, a mounting bracket, a clamp, a rail, a magnetic plate, a rope, a chain, a wire, a cable, arms, a leg, a hook, a hanger, a strut, a mounting fastener, a wall mount, and a belt.

17. The modular, photovoltaic utility pole system of claim 1, wherein the base is selected from a group consisting of a floor, a ground, a surface, a wall, a mounting pole, a utility pole, a light pole, a post, a bracket, bucket, container, a structure, a bollard, an anchor, and a frame.

18. The modular, photovoltaic utility pole system of claim 1, wherein the support module further affixes an item selected from a group consisting of a signage, a traffic signage, a sensor, an arm, a mast, a staff, a chain, a cable, a bar, a tag, a barcode, a bird spike, an advertisement, a banner, a display, a decoration, an auxiliary electricity generator, and a charging platform.

19. The modular, photovoltaic utility pole system of claim 1, wherein the support module affixes the optoelectronic module in response to at least one of solar noon, shading from surrounding objects, reflectivity from surrounding objects, aesthetic, traffic, and safety.

20. The modular, photovoltaic utility pole system of claim 1, wherein the support module adjustably affixes the optoelectronic module to the base.
